(19) United States
(12) Patent Application Publication
(10) Pub. No.: US 2026/0062964 A1
(43) Pub. Date: Mar. 5, 2026

(54) AIRCRAFT DOOR LOCKING SYSTEM COMPRISING A MONITORING SYSTEM SIGNALING WHETHER THE LOCKING SYSTEM IS IN A LOCKED OR UNLOCKED STATE

(71) Applicant: AIRBUS HELICOPTERS, Marignane Cedex (FR)

(72) Inventors: Fleur HUGUET, Toulon (FR); Pierre FRUITET, Pompignan (FR); Lilian GAIA, Rognac (FR); Jérôme DARGNAT, Mimet (FR)

(73) Assignee: AIRBUS HELICOPTERS, Marignane Cedex (FR)

(21) Appl. No.: 19/209,677

(22) Filed: May 15, 2025

(30) Foreign Application Priority Data
Aug. 30, 2024 (FR) FR2409276

(51) Int. Cl. E05B 77/22; B64C 1/14

(52) U.S. Cl. CPC E05B 77/22; B64C 1/1407; E05Y 2900/502

(57) ABSTRACT

A locking system for locking a door comprising at least two locks. The locking system has one position sensor per lock, each position sensor emitting a measurement signal bearing a locked state or an unlocked state of the associated lock, the signaling system comprising a controller receiving the measurement signals and being connected to an alerter, the controller being configured to emit either an unlocking signal when at least one measurement signal bears an unlocked state of the associated lock or a locking signal if each measurement signal bears a locked state of the associated lock, the alerter generating a visual unlocking alert following receipt of the unlocking signal and a visual locking alert following receipt of the locking signal.

### CROSS REFERENCE TO RELATED APPLICATION

This application claims priority to French Patent the application No. FR 24 09276 filed on Aug. 30, 2024, disclosure of which is incorporated in its entirety by reference herein.

### TECHNICAL FIELD

The present disclosure relates to an aircraft door locking system comprising a monitoring system signaling whether the locking system is in a locked or unlocked state.

### BACKGROUND

An aircraft door is movable relative to a carrier between an open position and a closed position. The door is usually provided with a locking system to keep the door in the closed position. Such a locking system conventionally comprises a lock.

Aircraft certification regulations require the establishment of means for visually verifying that a door to the outside of the aircraft is locked in the closed position, namely to verify that the locking system locks the door in this closed position. For example, Chapter 783 of Regulation CS29 includes such a requirement.

Mechanical systems can thus be implemented on helicopters, and more generally on aircraft. For example, such a mechanical system comprises a movable member provided with a green zone visible when the locking system is locked, and a red zone visible when the locking system is unlocked. Although effective, these systems are subject to wear, due for example to the vibrations and accelerations undergone. In addition, some mechanical systems may give ambiguous information when the door is ajar, for example by showing both part of the green and red zones.

Document CN205604874U and document JP2010127065A describe mechanical systems.

Another known signaling system comprises a microswitch in conjunction with an alarm panel. When the associated door is opened, the microswitch is opened which generates an alarm displayed by the alarm panel. When the door is closed, the microswitch closes and the alarm disappears.

Another signaling system comprises a microswitch associated with a lock bolt to trigger an alarm if the lock bolt is not engaged.

Document WO2024055500 A1 discloses a system having a microswitch connected to a signaling system signaling the closed status of a door closing mechanism. The signaling system may comprise a light source arranged in a cockpit of a helicopter.

Document CN117513877A describes a device for a helicopter cabin door comprising: a monitoring unit, a display unit, a control unit, a locking mechanism, a locking actuation system, a cabin door actuation system, a cabin door locking signaler that, if necessary, emits a door locking signal in the closed position and, if necessary emits a door unlocking signal in the open position, a closed cabin door position sensor emitting, if necessary, a closed door signal, and a cabin door open position sensor emitting, if necessary, an open door locking signal.

When the closed cabin door position sensor emits a closed door signal, the control unit sends a locking command to the locking actuation system that locks the door. In the closed position, the cabin door locking signaler detects the locking and sends a door locking signal to the control unit that then transmits a signal to the display unit to signal the locking.

Document KR970054097U describes a system for detecting the opening of a door. The system includes: i) a chopper configured to convert an electrical voltage to a pulse voltage having a predetermined cycle, ii) a plurality of door switches, for which the switching state is controlled depending on whether the door is open or closed, and iii) an instrument panel warning light configured to receive an electrical current having a pulse voltage provided by the chopper when at least one door switch is activated and to illuminate according to a predetermined cycle.

Document US 2003/038713 A1 relates to a warning indication system and a method of using the same in conjunction with an upwardly opening aircraft loading door.

The method includes emitting signals when the loading door is in the closed position; emitting signals when the loading door is in the closed position and locked by a latch; and emitting signals when the loading door is in the closed position, locked by a latch and locked by a lock.

Documents US 2023/265687 A1, EP 3 495 269 B1, and EP 3 556 656 B1 are further from the disclosure.

### SUMMARY

An object of the present disclosure is therefore to propose an innovative signaling system that reliably and simply signals whether a locking system is in a locked or unlocked position.

The disclosure thus relates to a locking system for locking a door in a closed position with respect to a carrier, the locking system comprising at least two locks each capable of immobilizing the door in the closed position, the locking system having a signaling system.

The signaling system comprises one position sensor per lock, each position sensor emitting a measurement signal bearing a locked state or an unlocked state of the associated lock, the signaling system comprising a controller receiving the measurement signals and connected to an alerter, the controller being configured to emit either an unlocking signal when at least one measurement signal bears an unlocked state of the associated lock, or a locking signal if each measurement signal bears a locked state of the associated lock, the alerter generating a visual unlocking alert following receipt of the unlocking signal and a visual locking alert following receipt of the locking signal, the locking alert being different from the unlocking alert.

The term “lock” means a closing mechanism cooperating with a complementary member of a carrier in order to lock the door. For example, the lock comprises a hook that can clamp a member of the carrier, or a bolt that can be inserted into a strike plate.

Thus, the locking system comprises a plurality of position sensors, namely one position sensor for each lock. Each position sensor indicates to the controller whether the associated lock is locked or unlocked, i.e., to assess whether the associated lock is locked to a carrier to immobilize the door, or is not locked to the carrier.

If one or more position sensors indicate to the controller that the associated lock is not locked, the controller generates the unlocking alert. If each position sensor indicates to the controller that the associated lock is locked, the controller generates the locking alert.

Each alert takes the form of a visual alert, for example by means of light emitted by a light source such as a light-emitting diode or optionally an optical fiber output.

An operator can then visually see if all the locks are locked or if at least one lock is unlocked.

Thus, the signaling system proves to be simple, and/or may have a relatively low mass. The signaling system can also be used at night or in difficult weather conditions.

Furthermore, such a signaling system can be installed on an existing locking system.

The locking system may in addition comprise one or more of the following features, taken individually or in combination.

According to one possibility, each lock comprises an immobilizing member integral with a finger sliding in a slot of a frame of the lock, the immobilizing member and the finger being only movable with respect to the frame between a release position and a blocking position, each position sensor emitting a measurement signal bearing a locked state when the finger is in the blocking position and emitting a measurement signal bearing an unlocked state when the finger is in the release position.

The immobilizing member is made movable in order to cooperate in the blocking position with a fixed member of the carrier, the door then being locked in its closed position. Conversely, when the immobilizing member is in its release position, this immobilizing member is remote from this fixed member of the carrier, the door then not being locked in the closed position.

Each position sensor can then evaluate the position of the finger, that is in fact an image of the position of the immobilizing member. Such a position sensor may, for example, take the form of a Hall effect sensor or a conventional optical sensor.

The signaling system then comprises reliable position sensors to evaluate whether or not the locks are locked.

According to one possibility compatible with the preceding possibilities, each lock may comprise a shaft extending along an axis of rotation of the immobilizing member, the position sensor of a lock being mounted on the shaft of this lock.

The position sensor can thus be close to the finger to be monitored.

According to one possibility compatible with the preceding possibilities, the alerter may comprise at least one light source for generating the locking alert and the unlocking alert, the locking alert being in the form of a light of a first color and the unlocking alert being in the form of a light of a second color different from the first color.

The expression “light source” hereinafter designates a light emitter, such as, for example, a light-emitting diode or an optical fiber.

According to one example, the alerter includes a light source that emits a green light when a locking signal is received, and a light source that emits a red light when an unlocking signal is emitted.

According to another example, the alerter may comprise a locking light source to be illuminated in the presence of a locking signal, and one unlocking light source per position sensor to be illuminated when the measurement signal emitted by the associated position sensor bears an unlocked state.

Thus, an operator can evaluate the state of each lock.

According to one possibility compatible with the preceding possibilities, the locking system may comprise a dedicated electrical power source, electrically powering the signaling system.

The signaling system can then be autonomous and functional even when the aircraft is switched off. The signaling system may include a conventional charge indicator to indicate the level of charge of the electrical power source, for example an electrical battery.

According to one possibility compatible with the preceding possibilities, the locking system may be autonomous and independent.

The term “autonomous” means that the signaling system can function without external assistance, for example by having its own electrical power source.

The term “independent” means that the signaling system is not connected to another system, in particular to the avionics system of the aircraft.

Thus, the locking system is always functional, whether the aircraft is shut down or in operation.

According to one possibility compatible with the preceding possibilities, the controller may be configured to emit the unlocking signal and the locking signal for a predetermined time period.

Thus, the alerter is addressed for a limited period of time. This feature makes it possible, for example, to maximize the duration of use of an electric battery that is electrically supplying the signaling system.

According to one possibility compatible with the preceding possibilities, the signaling system may comprise at least one human-machine interface in communication with the controller, the controller being configured to emit the unlocking signal and the locking signal following an operation of the human-machine interface.

Thus, an operator can operate the human-machine interface. This human-machine interface emits a control signal received by the controller. The controller then emits the appropriate unlocking signal or locking signal based on the current measurement signals, in order to drive the alerter.

According to one possibility compatible with the preceding possibilities, the controller can be configured to emit the unlocking signal and the locking signal following a change in a measurement signal.

For example, at each change of state of a lock, an alert is generated, optionally for a predetermined time period, as previously explained.

Furthermore, a door may be provided with a locking system according to the disclosure.

Optionally, the alerter is visible on either side of the door.

When this door separates an interior space from an exterior space, the alerter is visible from the interior space and the exterior space.

The door may comprise a closure detection system provided with a closure sensor communicating with an alert generator. For example, the closure sensor comprises a microswitch connected to a light generator in order to indicate whether the door is closed. The closure detection system may be independent of the signaling system, and/or may be connected to the avionics system of the aircraft.

Furthermore, an aircraft may comprise such a door according to the disclosure.

Optionally, the signaling system is independent of an avionics system of the aircraft.

### BRIEF DESCRIPTION OF THE DRAWINGS

The disclosure and its advantages appear in greater detail from the following description of examples given by way of illustration with reference to the accompanying figures, wherein:

FIG. 1 is a diagram showing a locking system according to the disclosure;

FIG. 2 is a diagram showing a locked lock;

FIG. 3 is a door illustrating a locking system according to the disclosure; and

FIG. 4 shows the method implemented by a locking system according to the disclosure.

### DETAILED DESCRIPTION

Elements present in more than one of the figures are given the same references in each of them.

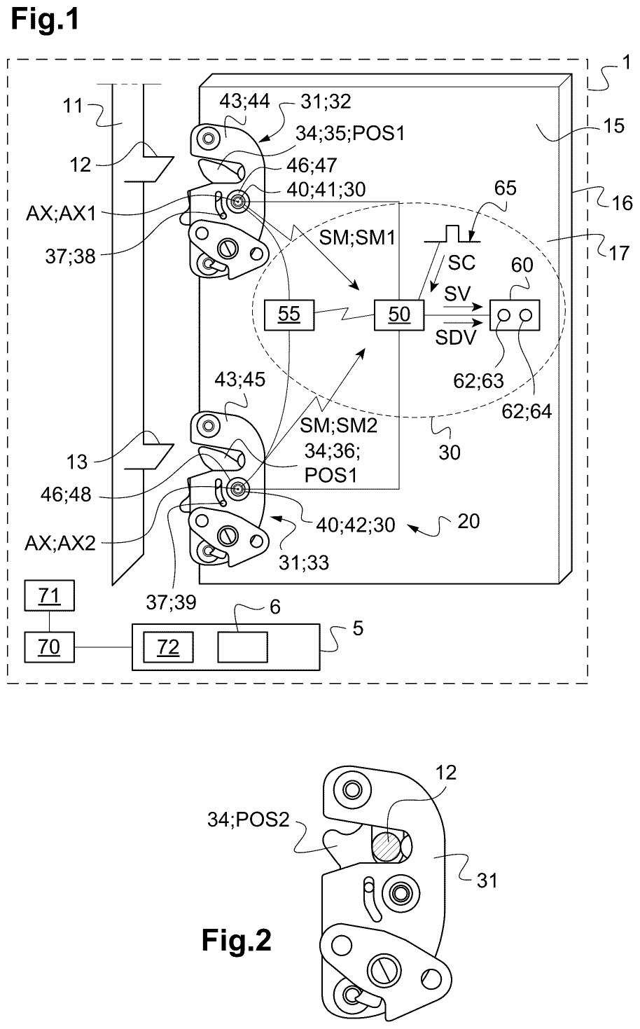

FIG. 1 shows a locking system 20 according to the disclosure for locking, i.e., immobilizing, a door 15 in a closed position in relation to a carrier 11.

The locking system 20 is thus arranged on a door 15 shown schematically. This door 15 extends in its thickness from the first face 16 to a second face 17. The locking system 20 may be at least partially housed in the thickness of the door 15.

Such a door 15 may be arranged within any structure. For example, such a door 15 may equip an aircraft 1, and for example a rotary-wing aircraft. In particular, the door 15 may be a cargo door, or a door giving access to a cabin or a cockpit, for example. The door 15 may be movable with respect to the carrier, mainly in rotation, or in translation according to the example given.

Irrespective of its design, the locking system 20 comprises at least two locks 31. The figures show only two locks by way of illustration, but the door may have three or more locks. Reference sign 31 designates any lock, with reference signs 32 and 33 designating particular locks. Each lock 31 has the function of immobilizing the door 15 in a closed position by cooperating with the carrier 11, namely in a position wherein the door 15 closes off a passage. When the door 15 is in an open position, it then becomes possible to pass through the passage.

Thus, each lock 31 may comprise an immobilizing member 34 that is able to move with respect to a frame 43. The function of such an immobilizing member is to keep the door closed or to allow the door to move. Reference sign 34 designates any immobilizing member, with reference signs 35 and 36 designating the immobilization members of the first lock 32 and of the second lock 33, respectively. Similarly, reference sign 43 designates any frame, with references 44, 45 designating the frames of the first lock 32 and of the second lock 33, respectively.

In particular, each immobilizing member 34 may take the form, for example, of a bolt that can move in translation in order to penetrate into a strike plate that is integral with the carrier 11, the bolt being able to be displaced in the conventional manner.

According to the illustrated example, each immobilizing member 34 may be in the form of a hook that is movable in rotation about an axis of rotation AX in order to clamp a fixed member 12, 13 of the carrier 11 against the frame or against an elastomer block carried by the frame according to the illustrated example. The movement of the hook may be obtained in a conventional manner, for example by being of the type of the lock described in document EP4299436.

Regardless of the embodiment, each immobilizing member 34 remains movable from a release position POS1 to a blocking position POS2. In the release position POS1 illustrated in FIG. 1, the immobilizing member 34 is not engaged with a fixed member 12, 13 integral with the carrier 11. In the blocking position POS2 illustrated in FIG. 2, the immobilizing member 34 is engaged with this fixed member 12, 13 integral with the carrier 11 in order to immobilize the door 15 with respect to the carrier 11.

Furthermore, and with reference to FIG. 1, the locking system 20 comprises a signaling system 30, the function of which is to indicate whether the locks are locked or not locked.

The signaling system 30 then comprises one position sensor 40 per lock 31. Reference sign 40 designates any position sensor, with reference signs 41 and 42 designating position sensors of the first lock 32 and of the second lock 33, respectively. The term “sensor” should be understood to mean a physical sensor capable of directly measuring the parameter in question, but also a system that may comprise one or more physical sensors, as well as means for processing the signal that make it possible to provide an estimation of the parameter based on the measurements provided by these physical sensors. For example, each position sensor 40 may comprise a conventional Hall effect or optical sensor.

Each position sensor 40 has the function of emitting a measurement signal SM bearing a locked state or an unlocked state of the associated lock 31 as a function of the current situation. The locked state is achieved by a lock 31 when its immobilizing member 34 is in a blocking position enabling it to be engaged with a fixed member 12, 13 of the carrier 11, the lock 31 otherwise being in the unlocked state.

For example, each lock 31 comprises a finger 37 integral with the immobilizing member 34 of this lock 31. The finger 37 slides in a slot of the frame. Reference sign 37 designates any finger, with reference signs 38 and 39 designating fingers of the first lock 32 and of the second lock 33, respectively. Each finger 37 has, in particular, the function of identifying the position of the immobilizing member 34. Each position sensor 40 then emits a measurement signal SM bearing a locked state when the finger 37 is in the blocking position POS2, and a measurement signal SM bearing an unlocked state when the finger 37 is in the release position POS1. Reference sign SM designates any measurement signal, with the reference signs SM1, SM2 designating the measurement signals emitted by the first position sensor 41 and the second position sensor 42, respectively.

In the presence of an immobilizing member 34 movable only according to one degree of freedom in rotation about a shaft 46 extending along an axis of rotation AX, the position sensor 40 may be mounted on this shaft 46. Reference sign 46 designates any shaft, with the reference signs 47 and 48 designating shafts arranged along axes of rotation AX1, AX2 of the first lock 32 and of the second lock 33, respectively. Furthermore, the frame 43 may comprise a slot in the form of an arc of a circle, guiding the finger 37 of this lock 31.

In another aspect, the signaling system 30 comprises a controller 50 connected by a wired or wireless link to each position sensor 40. For example, the controller 50 may comprise a microcontroller or any other alternative device.

Moreover, the controller 50 is connected by a wired or wireless link to an alerter 60 capable of generating at least two visually different alerts. The alerter 60 may be integrated with the door 15 or offset outside of the door 15.

Furthermore, the locking system 20 may comprise at least one, optionally dedicated, electrical power source 55, such as an electric battery, electrically powering the signaling system 30. The electrical power source 55 may electrically power the position sensors 40, and/or the controller 50, and/or the alerter 60, for example.

In this context, the controller 50 receives the measurement signals SM. The controller 50 is then configured to emit an alert signal to the alerter 60. This alert signal may be either an unlocking signal SDV when at least one measurement signal SM bears an unlocked state of the associated lock 31, or a locking signal SV if each measurement signal bears a locked state of the associated lock 31. In response, the alerter 60 issues a visual unlocking alert following receipt of the unlocking signal and a visual locking alert following receipt of the locking signal, the locking alert being different from the unlocking alert.

In order to optimize the signaling of the current state of the locking system 20, the alerter 60 may be visible on either side of the door 15, for example by being integrated into the door 15 optionally between the first face 16 and the second face 17. In other words, an individual is able to see the alert, whether that individual is facing the first face 16 or the second face 17.

For example, the alerter 60 comprises at least one light source 62 for generating the locking alert and the unlocking alert. The locking alert may take the form of a light of a first color, for example green. The unlocking alert may take the form of a light of a second color, distinct from the first color, for example red. If necessary, the door 15 is pierced so that the light source or sources 62 are visible on either side of this door 15.

According to the illustrated example, the alerter 60 may comprise a light source 63 for emitting the unlocking alert, and at least one light source 64 for emitting the locking alert. Optionally, the alerter 60 comprises a single light source 64 that illuminates if at least one lock is not locked, or one light source 64 per lock that illuminates if the associated lock is not locked.

According to one possibility, the controller 50 may be configured to output the unlocking signal and the locking signal for a predetermined time period and/or the alert is configured to output the unlocking alert and the locking alert for the predetermined time period.

For example, the controller 50 is configured to emit the unlocking signal and the locking signal as a result of a change in a measurement signal, i.e., when the state borne by a measurement signal changes. In other words, if a lock 31 changes from a locked state to an unlocked state, or vice versa, the controller 50 drives the alerter 60 to display an alert.

According to one possibility, the signaling system 30 may comprise at least one human-machine interface 65 in wired or wireless communication with the controller 50. The human-machine interface 65 may be carried by the door, or may be offset. For example, the human-machine interface 65 comprises a button, a touchpad, a voice interface or others, these examples being given simply for illustrative purposes. When an operator addresses this human-machine interface 65, the controller 50 is configured to emit the alert signal to the alerter 60. At any time, an operator can then check whether the door 15 is locked or not locked.

According to another aspect, the locking system 20 may be autonomous and independent.

For example, the signaling system 30 may be independent of an avionics system 5 of the aircraft 1. Alternatively, the controller 50 may transmit an alert signal to an additional alerter 6 of the avionics system 5.

According to another aspect, the door may comprise a closure detection system provided with a closure sensor 70 communicating with an independent alert generator 71 and/or with an alert generator 72 of the avionics system 5. The closure detection system may be independent of the signaling system, and/or may be connected to the avionics system of the aircraft.

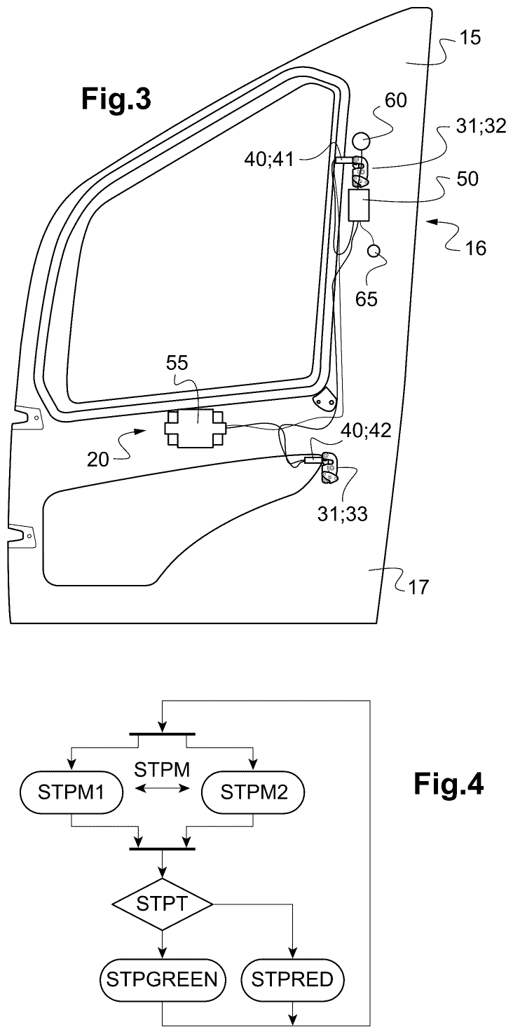

FIG. 3 illustrates a door 15 provided with a locking system 20 according to the disclosure.

FIG. 4 illustrates the method applied by the locking system 20.

During an STPM measurement step, each position sensor 40 emits a measurement signal SM to the controller 50. According to the example shown, the first position sensor 41 emits a first measurement signal SM1 during a first step STPM1, and the second position sensor 42 emits a second measurement signal SM2 during a second step STPM2.

During an STPT test step, the controller 50 determines whether at least one measurement signal bears an unlocked state of the associated lock 31.

If so, the controller 50 emits, during an STPRED step, an alert signal of the unlocking signal type to the alerter 60, that consequently generates an unlocking alert.

Otherwise, the controller 50 emits, during an STPGREEN step, an alert signal of the locking signal type to the alerter 60 that consequently generates a locking alert.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A locking system for locking a door in a closed position with respect to a carrier, the locking system comprising at least two locks each capable of immobilizing the door in the closed position, the locking system having a signaling system,
wherein the signaling system includes one position sensor per lock, each position sensor emitting a measurement signal bearing a locked state or an unlocked state of the associated lock, the signaling system comprising a controller receiving the measurement signals and connected to an alerter, the controller being configured to emit either an unlocking signal when at least one measurement signal bears an unlocked state of the associated lock or a locking signal if each measurement signal bears a locked state of the associated lock, the alerter generating a visual unlocking alert following receipt of the unlocking signal and a visual locking alert following receipt of the locking signal, the locking alert being different from the unlocking alert.

2. The locking system according to claim 1,
wherein each lock comprises an immobilizing member integral with a finger sliding in a slot of a frame of the lock, the immobilizing member and the finger being only movable with respect to the frame between a release position and a blocking position, each position sensor emitting a measurement signal bearing a locked state when the finger is in the blocking position and emitting a measurement signal bearing an unlocked state when the finger is in the release position.

3. The locking system according to claim 1,
wherein each lock comprises a shaft extending along an axis of rotation of the immobilizing member, and the position sensor of a lock is mounted on the shaft of this lock.

4. The locking system according to claim 1,
wherein the alerter comprises at least one light source for generating the locking alert and the unlocking alert, the locking alert being in the form of a light of a first color and the unlocking alert being in the form of a light of a second color different from the first color.

5. The locking system according to claim 1,
wherein the locking system includes a dedicated signaling electrical power source electrically powering the system.

6. The locking system according to claim 1,
wherein the locking system is autonomous and independent.

7. The locking system according to claim 1,
wherein the controller is configured to emit the unlocking signal and the locking signal for a predetermined time period.

8. The locking system according to claim 1,
wherein the signaling system comprises at least one human-machine interface in communication with the controller, the controller being configured to output the unlocking signal and the locking signal as a result of an operation of the human-machine interface.

9. The locking system according to claim 1,
wherein the controller is configured to output the unlocking signal and the locking signal as a result of a change in a measurement signal.

10. A door provided with the locking system,
wherein the locking system is according to claim 1.

11. The door according to claim 10,
wherein the alerter is visible on either side of the door.

12. The door according to claim 10,
wherein the door comprises a closure detection system provided with a closure sensor communicating with an alert generator.

13. An aircraft,
wherein the aircraft comprises a door according to claim 10.

14. The aircraft according to claim 13,
wherein the signaling system is independent of an avionics system of the aircraft.
